(19) United States
(12) Patent Application Publication
(10) Pub. No.: US 2025/0151007 A1
(43) Pub. Date: May 8, 2025

(54) METHOD FOR IDENTIFYING MOBILE COMMUNICATION DEVICE PRESENT AT SPECIFIC LOCATION

(71) Applicants: Safe Korea Co., Ltd., Icheon-si (KR); Fureun Co., Ltd., Seoul (KR)

(72) Inventors: Sang Seo LEE, Uiwang-si (KR); Dong Soo GIL, Anyang-si (KR)

(21) Appl. No.: 18/832,566

(22) PCT Filed: Jan. 26, 2022
(86) PCT No.: PCT/KR2022/001349

§ 371 Date: Jul. 24, 2024

(30) Foreign Application Priority Data
Jan. 25, 2022 (KR) 10-2022-0010799

(51) Int. Cl. H04W 64/00; H04W 4/90

(52) U.S. Cl. CPC H04W 64/00; H04W 4/90

(57) ABSTRACT

According to the present invention, at a specific location where a mobile short-range wireless communication means 200, which is mobile and generates short-range wireless communication signals, is temporarily provided, a base station communication and identification device 80 placed at the specific location identifies the identification information of the surrounding base stations. A communication service provider's server 400, having received this information, identifies the phone numbers of mobile communication devices communicating with the base stations based on the identification information of the surrounding base stations and activates the emergency position tracking apps 608 installed on these mobile communication devices to receive their location tracking information. Subsequently, a positioning server 900 identifies that the mobile communication devices, corresponding to the mobile communication devices having the identification information of the temporarily provided mobile short-range wireless communication means 200 from the location tracking information collected and transmitted by the emergency position tracking apps 608 on the mobile communication devices, are present at the specific location.

### TECHNICAL FIELD

The present invention relates to a method for identifying mobile communication devices, such as smart phones, located at a specific location. More specifically, it pertains to a method for determining the number of mobile communication devices, such as smart phones, and their phone numbers at a given location, such as a specific building or a specific place within a building.

### BACKGROUND ART

Currently, there are methods available to track the location of mobile communication devices, such as smart phones, when their phone numbers are provided in emergency situations.

This method involves servers of communication service providers sending push messages to the mobile communication devices associated with the given phone numbers at the request of government agencies such as the Fire Department. This activates emergency position tracking apps installed on these devices, which then collect location tracking information (such as wireless LAN AP information, GPS information, and base station information) from the vicinity of the devices. This information is then transmitted to the servers of the communication service providers. The servers of the communication service providers, or associated positioning servers, use the received location tracking information to determine the locations of the mobile communication devices associated with the given phone numbers.

Currently, in emergency situations such as fires, government agencies like the Fire Department provide the phone numbers to the relevant communication service providers via the Korea Telecommunications Operators Association (KTOA) to track the locations of the mobile communication devices associated with those phone numbers.

However, there is no method available to identify mobile communication devices, such as smart phones, present at a specific location when that location is provided.

For example, in the event of a fire in a specific building, there is no method to identify the smart phones present in that building.

In another instance, if an incident such as a burglary or terrorist attack occurs in a specific building, there is no method to identify the smart phones present in that building.

In the case of the fire, simply identifying the number of smartphones present in the burning building can help estimate the number of people inside, which can be very useful for rescue operations.

On the other hand, in cases of incidents such as burglary or terrorism, identifying the phone numbers of the smart phones present in the building can help track the individuals carrying them.

Additionally, in buildings such as apartments or subways, or during construction work on these buildings or subways, it is necessary to determine whether people are present at a specific location.

In light of these various situations, there is a demand for a method to identify mobile communication devices, such as smart phones, present at a specific location when that location is specified. The present invention addresses and fulfills this demand.

There is a method for tracking the location of devices during a disaster described in Korean Patent No. 10-2110217-0000, titled ‘System and Method for Tracking the Location of Rescue Personnel within a Disaster Building’.

### DETAILED DESCRIPTION OF THE INVENTION

### Technical Problem

The objective of the present invention is to provide a method for identifying mobile communication devices, such as smart phones, present at a specific location.

### Technical Solution

The present invention provides

a method for identifying mobile communication devices located at a specific location, the method comprising:

(a) Surrounding Base Station Identification Step, wherein a base station communication and identification device, which is configured to identify and transmit identification information of surrounding base stations, including that of communicating base station with which it is communicating, by being positioned at or near a specific location, identifies the identification information of the surrounding base stations;

(b) Base Station Identification Information Transmission Step, wherein the identification information of the surrounding base stations identified by the base station communication and identification device is transmitted to servers of communication service providers to which the base station belongs;

(c) Mobile Communication Device Phone Number Identification Step, wherein the servers of the communication service providers identify phone numbers of the mobile communication devices communicating with the base stations according to the identification information of the surrounding base stations;

(d) Emergency Location Tracking App Activation Step, wherein the servers of the communication service providers, having identified the phone numbers of the mobile communication devices, activate emergency position tracking apps installed on the mobile communication devices associated with those phone numbers; wherein the emergency position tracking app is an application that collects and transmits the location tracking information of the mobile communication device on which it is installed,

(e) Specific Location Presence Mobile Communication Device Identification Step, wherein positioning means identify the mobile communication devices located at the specific location based on the location tracking information collected and transmitted by the emergency position tracking apps on the mobile communication devices.

According to the present invention, it is preferable that, in the Surrounding Base Station Identification Step, the identification information of the surrounding base stations includes the identification information of the communicating base station and identification information of neighboring base stations of the communicating base station.

According to the present invention, it is preferable that the Base Station Identification Information Transmission Step includes transmitting the identification information to the servers of the communication service providers via a government agency server and the Korea Telecommunications Operators Association server.

According to the present invention, it is preferable that, in the Specific Location Presence Mobile Communication Device Identification Step, the mobile communication devices located at the specific location are identified by using any one or a combination of identification information of short-range wireless communication means, identification information of base stations, or GPS information from the location tracking information.

According to the present invention, it is preferable that information identified by the Specific Location Presence Mobile Communication Device Identification Step includes the number of mobile communication devices located at the specific location and/or the phone numbers of these mobile communication devices.

According to the present invention, it is preferable that,

(a) a mobile short-range wireless communication means, which generates short-range wireless communication signals, is temporarily provided at the specific location, and

(b) in the Specific Location Presence Mobile Communication Device Identification Step, the mobile communication devices that have the identification information of the temporarily provided mobile short-range wireless communication means from the location tracking information collected and transmitted by the emergency position tracking apps of the mobile communication devices are identified as being located at the specific location.

The present invention provides

a method for identifying mobile communication devices located at a specific location by a communication service provider server, the method comprising:

(a) Mobile Communication Device Phone Number Identification Step, wherein, based on identification information of surrounding base stations identified and transmitted by a base station communication and identification device, which is configured to identify and transmit the identification information of the surrounding base stations, including that of a communicating base station with which it is communicating, by being positioned at or near a specific location, phone numbers of mobile communication devices communicating with the base stations are identified according to the identification information of the surrounding base stations;
(b) Emergency Position Tracking App Activation Step, wherein emergency location tracking apps installed on the mobile communication devices associated with the identified phone numbers are activated; wherein each of the emergency location tracking apps collects and transmits the location tracking information of the mobile communication device on which it is installed;
(c) Specific Location Presence Mobile Communication Device Identification Step, wherein the mobile communication devices located at the specific location are identified based on the location tracking information collected and transmitted by the emergency position tracking apps of the mobile communication devices.
According to the present invention, it is preferable that,
(a) a mobile short-range wireless communication means, which generates short-range wireless communication signals, is temporarily provided at the specific location, and
(b) in the Specific Location Presence Mobile Communication Device Identification Step, the mobile communication devices that have the identification information of the temporarily provided mobile short-range wireless communication means from the location tracking information collected and transmitted by the emergency position tracking apps of the mobile communication devices are identified as being located at the specific location.
The present invention provides
a method for identifying mobile communication devices located at a specific location by a positioning server, the method comprising:
(a) By a communication service provider server,
(a1) based on identification information of surrounding base stations identified and transmitted by a base station communication and identification device, which is configured to identify and transmit the identification information of the surrounding base stations, including that of a communicating base station with which it is communicating, by being positioned at or near a specific location, identifying phone numbers of mobile communication devices communicating with base stations according to the identification information of surrounding base stations; and
(a2) activating emergency position tracking apps installed on the mobile communication devices associated with the identified phone numbers and receiving location tracking information collected and transmitted by the emergency position tracking apps, wherein each of the emergency position tracking apps collects and transmits the location tracking information of the mobile communication device on which it is installed; and
(b) Specific Location Presence Mobile Communication Device Identification Step, wherein the positioning server receives the location tracking information collected and transmitted by the emergency position tracking apps from the communication service provider server and identifies the mobile communication devices located at the specific location.
According to the present invention, it is preferable that,
(a) a mobile short-range wireless communication means, which generates short-range wireless communication signals, is temporarily provided at the specific location, and
(b) in the Specific Location Presence Mobile Communication Device Identification Step, the mobile communication devices that have the identification information of the temporarily provided mobile short-range wireless communication means from the location tracking information collected and transmitted by the emergency position tracking apps of the mobile communication devices are identified as being located at the specific location.
The present invention provides
a method for identifying mobile communication devices located at a specific location by a communication service provider server, the method comprising:
(a) based on identification information of surrounding base stations identified and transmitted by a base station communication and identification device, which is configured to identify and transmit the identification information of the surrounding base stations, including that of a communicating base station with which it is communicating, by being positioned at or near a specific location, identifying phone numbers of mobile communication devices communicating with the base stations according to the identification information of the surrounding base stations,
(b) activating emergency position tracking apps installed on the mobile communication devices associated with the identified phone numbers and receiving location tracking information collected and transmitted by the emergency position tracking apps, wherein the emergency position tracking app is an application that collects and transmits the location tracking information of the mobile communication device on which it is installed, and
(c) transmitting the location tracking information collected and transmitted by the emergency position tracking apps to a positioning server,
(d) wherein the positioning server identifies the mobile communication devices located at the specific location according to the location tracking information collected and transmitted by the emergency position tracking apps of the mobile communication devices.
According to the present invention, it is preferable that,
(a) a mobile short-range wireless communication means, which generates short-range wireless communication signals, is temporarily provided at the specific location, and
(b) the positioning server identifies that the mobile communication devices, which have the identification information of the temporarily provided mobile short-range wireless communication means from the location tracking information collected and transmitted by the emergency position tracking apps on the mobile communication devices are located at the specific location.
The present invention provides, with respect to a method for identifying mobile communication devices located at a specific location, the method comprising:
(a1) Surrounding Base Station Identification Step, wherein a base station communication and identification device, which is configured to identify and transmit identification information of surrounding base stations, including that of communicating base station with which it is communicating, by being positioned at or near a specific location, identifies the identification information of the surrounding base stations;
(a2) Base Station Identification Information Transmission Step, wherein the identification information of the surrounding base stations identified by the base station communication and identification device is transmitted to server of communication service provider to which the base station belongs;
(a3) Mobile Communication Device Phone Number Identification Step, wherein the server of the communication service provider identifies phone numbers of the mobile communication devices communicating with the base stations according to the identification information of the surrounding base stations;
(a4) Emergency Location Tracking App Activation Step, wherein the server of the communication service provider, having identified the phone numbers of the mobile communication devices, activates emergency position tracking apps installed on the mobile communication devices associated with those phone numbers; wherein the emergency position tracking app is an application that collects and transmits the location tracking information of the mobile communication device on which it is installed,
(a5) Specific Location Presence Mobile Communication Device Identification Step, wherein positioning means identifies the mobile communication devices located at the specific location based on the location tracking information collected and transmitted by the emergency position tracking apps on the mobile communication devices, and
(b) the mobile short-range wireless communication means used for the method for identifying mobile communication devices located at a specific location.
The present invention provides,
with respect to a method for identifying mobile communication devices located at a specific location, the method comprising:
(a1) Surrounding Base Station Identification Step, wherein a base station communication and identification device, which is configured to identify and transmit identification information of surrounding base stations, including that of communicating base station with which it is communicating, by being positioned at or near a specific location, identifies the identification information of the surrounding base stations;
(a2) Base Station Identification Information Transmission Step, wherein the identification information of the surrounding base stations identified by the base station communication and identification device is transmitted to server of communication service provider to which the base station belongs;
(a3) Mobile Communication Device Phone Number Identification Step, wherein the server of the communication service provider identifies phone numbers of the mobile communication devices communicating with the base stations according to the identification information of the surrounding base stations;
(a4) Emergency Location Tracking App Activation Step, wherein the server of the communication service provider, having identified the phone numbers of the mobile communication devices, activates emergency position tracking apps installed on the mobile communication devices associated with those phone numbers; wherein the emergency position tracking app is an application that collects and transmits the location tracking information of the mobile communication device on which it is installed, and
(a5) Specific Location Presence Mobile Communication Device Identification Step, wherein positioning means identifies the mobile communication devices located at the specific location based on the location tracking information collected and transmitted by the emergency position tracking apps on the mobile communication devices,
(b) the base station communication and identification device used for the method for identifying mobile communication devices located at a specific location.
The present invention provides
a method for identifying mobile communication devices located at a specific location, the method comprising:
(a) Temporary Provision of a Mobile Short-range Wireless Communication Means Step, wherein a mobile short-range wireless communication means, which is mobile, generates short-range wireless communication signals, and has a provision location display means that displays location information where it is provided, is temporarily provided at a specific location according to the location information;
(b) Surrounding Base Station Identification Step, wherein a base station communication and identification device, which is configured to identify and transmit identification information of surrounding base stations, including that of a communicating base station with which it is communicating, by being positioned at or near a specific location, identifies the identification information of the surrounding base stations;
(c) Base Station Identification Information Transmission Step, wherein the identification information of the surrounding base stations identified by the base station communication and identification device is transmitted to servers of communication service providers to which the base station belongs;
(d) Mobile Communication Device Phone Number Identification Step, wherein the servers of the communication service providers identify phone numbers of mobile communication devices communicating with the base stations according to the identification information of the surrounding base stations;
(e) Emergency Location Tracking App Activation Step, wherein the servers of the communication service providers, having identified the phone numbers of the mobile communication devices, activate emergency position tracking apps installed on the mobile communication devices associated with those phone numbers, wherein the emergency position tracking app is an application that collects and transmits the location tracking information of the mobile communication device on which it is installed, and
(f) Specific Location Presence Mobile Communication Device Identification Step, wherein positioning means identify that the mobile communication devices, which have identification information of the temporarily provided mobile short-range wireless communication means from the location tracking information collected and transmitted by the emergency position tracking apps on the mobile communication devices, are located at the specific location.
According to the present invention, it is preferable that the location information at a specific location includes an address, a map indication with a rough map, or a description of the location to be provided.
According to the present invention, it is preferable that the temporary provision step of a mobile short-range wireless communication means includes throwing the mobile short-range wireless communication means to the specific location or moving and placing it at the specific location according to the location information.
According to the present invention, it is preferable that, in the surrounding base station identification step, the identification information of the surrounding base stations includes the identification information of the communicating base station and the identification information of the neighboring base stations of the communicating base station.
According to the present invention, it is preferable that the Base Station Identification Information Transmission Step includes transmitting the identification information to the servers of the communication service providers via a government agency server and the Korea Telecommunications Operators Association server.
According to the present invention, it is preferable that information identified by the Specific Location Presence Mobile Communication Device Identification Step includes the number of mobile communication devices located at the specific location and/or the phone numbers of these mobile communication devices.
The present invention provides
a method for identifying mobile communication devices located at a specific location by a communication service provider server, the method comprising:
(a) Mobile Communication Device Phone Number Identification Step, wherein, with respect to a specific location where a mobile short-range wireless communication means, which is mobile, generates short-range wireless communication signals, and has a provision location display means that displays location information where it is provided, is temporarily provided, based on identification information of surrounding base stations identified and transmitted by a base station communication and identification device, which is configured to identify and transmit the identification information of the surrounding base stations, including that of a communicating base station with which it is communicating, by being positioned at or near the specific location, phone numbers of mobile communication devices communicating with the base stations are identified according to the identification information of the surrounding base stations;
(b) Emergency Position Tracking App Activation Step, wherein emergency position tracking apps installed on the mobile communication devices associated with the identified phone numbers are activated, wherein each of the emergency position tracking apps collects and transmits location tracking information of the mobile communication device on which it is installed; and
(c) Specific Location Presence Mobile Communication Device Identification Step, wherein the mobile communication devices, which have identification information of the temporarily provided mobile short-range wireless communication means from the location tracking information collected and transmitted by the emergency position tracking apps on the mobile communication devices, are identified as being present at the specific location.
The present invention provides
a method for identifying mobile communication devices located at a specific location by a positioning server, the method comprising:
(a) by a communication service provider server,
(a1) with respect to a specific location where a mobile short-range wireless communication means, which is mobile, generates short-range wireless communication signals, and has a provision location display means that displays location information where it is provided, is temporarily provided, based on identification information of surrounding base stations identified and transmitted by a base station communication and identification device, which is configured to identify and transmit the identification information of the surrounding base stations, including that of a communicating base station with which it is communicating, by being positioned at or near the specific location, identifying phone numbers of mobile communication devices communicating with the base stations according to the identification information of the surrounding base stations;
(a2) activating emergency position tracking apps installed on the mobile communication devices associated with the identified phone numbers and receiving location tracking information collected and transmitted by the emergency position tracking apps, wherein each of the emergency position tracking apps collects and transmits location tracking information of the mobile communication device on which it is installed, and
(b) Specific Location Presence Mobile Communication Device Identification Step wherein the position server receives the location tracking information collected and transmitted by the emergency position tracking apps transmitted from the communication service provider server and identifies that the mobile communication devices, which have identification information of the temporarily provided mobile short-range wireless communication means from the location tracking information are present at the specific location.
The present invention provides
a method for identifying mobile communication devices located at a specific location by a communication service provider server, the method comprising:
(a) with respect to a specific location where a mobile short-range wireless communication means, which is mobile, generates short-range wireless communication signals, and has a provision location display means that displays location information where it is provided, is temporarily provided, based on identification information of surrounding base stations identified and transmitted by a base station communication and identification device, which is configured to identify and transmit the identification information of the surrounding base stations, including that of a communicating base station with which it is communicating, by being positioned at or near the specific location, identifying phone numbers of mobile communication devices communicating with the base stations according to the identification information of the surrounding base stations;
(b) activating emergency position tracking apps installed on the mobile communication devices associated with the identified phone numbers and receiving location tracking information collected and transmitted by the emergency position tracking apps, wherein each of the emergency position tracking apps collects and transmits the location tracking information of the mobile communication device on which it is installed, and
(c) transmitting the location tracking information collected and transmitted by the emergency position tracking apps to a positioning server,
(d) wherein the position server identifies that the mobile communication devices, which have identification information of the temporarily provided mobile short-range wireless communication means from the location tracking information are present at the specific location.
The present invention provides
with respect to a method for identifying mobile communication devices located at a specific location comprising:
(a1) Temporary Provision of a Mobile Short-range Wireless Communication Means Step, wherein a mobile short-range wireless communication means, which is mobile, generates short-range wireless communication signals, and has a provision location display means that displays location information where it is provided, is temporarily provided at a specific location according to the location information;
(a2) Surrounding Base Station Identification Step, wherein a base station communication and identification device, which is configured to identify and transmit identification information of surrounding base stations, including that of a communicating base station with which it is communicating, by being positioned at or near a specific location, identifies the identification information of the surrounding base stations;
(a3) Base Station Identification Information Transmission Step, wherein the identification information of the surrounding base stations identified by the base station communication and identification device is transmitted to servers of communication service providers to which the base station belongs;
(a4) Mobile Communication Device Phone Number Identification Step, wherein the servers of the communication service providers identify phone numbers of the mobile communication devices communicating with the base stations according to the identification information of the surrounding base stations;
(a5) Emergency Location Tracking App Activation Step, wherein the servers of the communication service providers, having identified the phone numbers of the mobile communication devices, activate emergency position tracking apps installed on the mobile communication devices associated with those phone numbers, wherein the emergency position tracking app is an application that collects and transmits the location tracking information of the mobile communication device on which it is installed, and
(a6) Specific Location Presence Mobile Communication Device Identification Step, wherein positioning means identify that the mobile communication devices, which have identification information of the temporarily provided mobile short-range wireless communication means from the location tracking information collected and transmitted by the emergency position tracking apps on the mobile communication devices, are present at the specific location,
(b) the mobile short-range wireless communication means used for the method for identifying mobile communication devices located at a specific location.
The present invention provides
with respect to a method for identifying mobile communication devices located at a specific location comprising:
(a1) Temporary Provision of a Mobile Short-range Wireless Communication Means Step, wherein a mobile short-range wireless communication means, which is mobile, generates short-range wireless communication signals, and has a provision location display means that displays location information where it is provided, is temporarily provided at a specific location according to the location information;
(a2) Surrounding Base Station Identification Step, wherein a base station communication and identification device, which is configured to identify and transmit identification information of surrounding base stations, including that of a communicating base station with which it is communicating, by being positioned at or near a specific location, identifies the identification information of the surrounding base stations;
(a3) Base Station Identification Information Transmission Step, wherein the identification information of the surrounding base stations identified by the base station communication and identification device is transmitted to servers of communication service providers to which the base station belongs;
(a4) Mobile Communication Device Phone Number Identification Step, wherein the servers of the communication service providers identify phone numbers of the mobile communication devices communicating with the base stations according to the identification information of the surrounding base stations;
(a5) Emergency Location Tracking App Activation Step, wherein the servers of the communication service providers, having identified the phone numbers of the mobile communication devices, activate emergency position tracking apps installed on the mobile communication devices associated with those phone numbers, wherein the emergency position tracking app is an application that collects and transmits the location tracking information of the mobile communication device on which it is installed, and
(a6) Specific Location Presence Mobile Communication Device Identification Step, wherein positioning means identify that the mobile communication devices, which have identification information of the temporarily provided mobile short-range wireless communication means from the location tracking information collected and transmitted by the emergency position tracking apps on the mobile communication devices, are present at the specific location,
(b) the base station communication and identification device used for the method for identifying mobile communication devices located at a specific location.

### The Effect of the Invention

The present invention provides a method for identifying mobile communication devices located at a specific location when that location is given.

### BRIEF DESCRIPTION OF THE DRAWINGS

FIG. 1 is a view showing the overall configuration of a system for implementing the method for identifying mobile communication devices located at a specific location according to the present invention;

FIG. 2 is a view showing the process of the method for identifying mobile communication devices located at a specific location according to the present invention;

FIG. 3 is a view showing that mobile short-range wireless communication means is temporarily provided at a specific location;

FIG. 4 is a view showing a provision location display means provided in the mobile short-range wireless communication means; and

FIG. 5 is a view showing an example of location information being displayed according to the provision location display means.

### DETAILED DESCRIPTION OF THE INVENTION

The preferred embodiments of the present invention will now be described in detail with reference to the accompanying drawings.

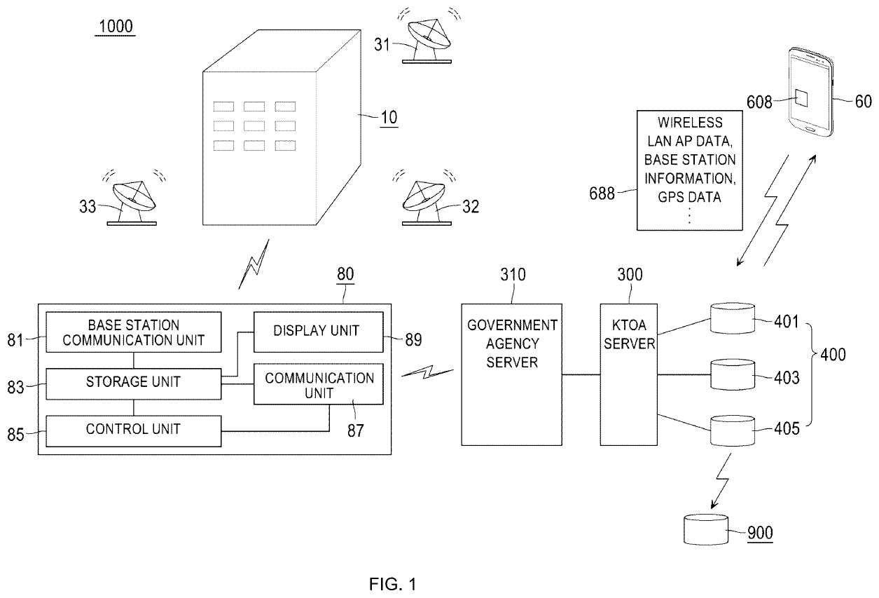

FIG. 1 illustrates the overall configuration 1000 of a system implementing the method for identifying a mobile communication device located at a specific position according to the present invention.

In the present invention, the mobile communication device refers to a device that allows the user to perform communications such as calls while moving and has an emergency position tracking app to collect and transmit location information.

The emergency position tracking app is an application that can collect and transmit location tracking information (such as wireless LAN AP information, GPS information, and base station information) of the mobile communication device it is installed on, under the control of the server of the communication service provider.

Currently, all smartphones in South Korea have the emergency position tracking app installed in accordance with the law, meeting the definition of a mobile communication device according to the present invention.

According to the present invention, base station communication and identification device 80 is provided.

The base station communication and identification device 80 is a device configured to identify and transmit identification information of surrounding base stations, including that of the communicating base station with which it is communicating, by being positioned at or near a specific location.

For example, the base station communication and identification device 80 includes a base station communication unit 81 that communicates with nearby base stations, stores the identification information (base station number) of the communicating base station in storage unit 83, transmits the identified identification information (base station number) via communication unit 87, and the entire process is controlled by a control unit 85.

According to the present invention, the base station communication and identification device 80 may have a display unit 89 to display the identification information of the mobile communication device located at the specific position.

The base station communication and identification device 80 basically identifies and transmits the identification information of the base station with which it communicates (communicating base station). Additionally, it is preferable to also capture and transmit the identification information (such as the numbers) of neighboring base stations, together with the identification information of the communicating base station.

That is, the base station communication and identification device 80 is preferably designed to also receive and transmit the identification information of neighboring base stations that is broadcasted while it communicates with the communicating base station. When there is a high number of the neighboring base stations, the device may be configured to select and transmit the identification information of the neighboring base stations within the range of a predetermined number, such as two or three, prioritizing those with the highest RF signal strengths, along with the identification information of the communicating base station.

Referring to FIG. 1, in the event of a disaster such as a fire, burglary, or terrorist attack at building 10, the base station communication and identification device 80 is positioned inside or around building 10 and is ready. It establishes communication with one of the nearby base stations 31, 32, or 33, captures, and transmits the identification information of both the communicating base station and its neighboring base stations.

That is, the base station communication and identification device 80 is located either inside building 10 or in the vicinity, such as in front of the building. It identifies and transmits the identification information of surrounding base station including the identification information of the communicating base station with which it is in communication.

In this way, the base station communication and identification device 80 captures and transmits the identification information of the surrounding base stations, including that of the communicating base station it is in communication with. According to this embodiment, the identification information of the surrounding base stations is first transmitted to server 310 of government agency such as the Fire Department or the Police Department. Subsequently, this information is forwarded to the server 350 of the Korea Telecommunications Operators Association (KTOA). The KTOA server (350) then transmits the received information to the respective servers 401, 402 and 403 of the communication service providers to which each base station belongs.

For example, the base station communication unit 81 of the base station communication and identification device 80 may include multiple sub-communication units, each configured to communicate with base stations of different communication service providers.

Therefore, the identification information of surrounding base stations, as detected by the base station communication unit that communicates with the base stations of the specific communication service provider, is transmitted to the server of the corresponding communication service provider.

In the accompanying drawings, the individual servers 401, 403 and 405 of the communication service providers are collectively denoted as the communication service provider server 400.

In this manner, the identification information of the surrounding base stations, as detected by the base station communication and identification device 80, is transmitted to the servers 401, 403, and 405 of the communication service providers to which each base station belongs.

Subsequently, the communication service providers' servers 401, 403, and 405, having received the identification information of the surrounding base stations transmitted by the base station communication and identification device 80, will identify the phone numbers of the mobile communication devices that are communicating with those base stations based on the received identification information.

For example, the communication service provider's server 401, having received the number of the base station 32 as the identification information of the communicating base station and the number of the base station 33 as the identification information of the neighboring base station, identifies the phone numbers of the mobile communication devices that are communicating with these base stations 32 and 33.

As such, upon recognizing the phone numbers of the mobile communication devices that are in communication with the base stations based on the identification information of the surrounding base stations, the communication service providers' servers 401, 403, and 405 control these mobile devices to activate the emergency position tracking apps installed on them. These apps then collect the location tracking information of these devices and transmit it back to the communication service providers' servers 401, 403, and 405.

For example, the communication service provider's server 401 recognizes the phone numbers of the mobile communication devices communicating with the communicating base station 32 and the neighboring base station 33 according to the previously mentioned identification information of the surrounding base stations. It then sends a push message to the mobile communication device 60 according to its phone number, activating the emergency position tracking app 608 installed on the device. This app collects the location tracking information of the mobile device 60 and transmits it back to the communication service provider's server 401.

In this case, although there may be multiple mobile communication devices, for simplicity of explanation, only one mobile communication device 60 has been illustrated.

The location tracking information 688 of the mobile communication device could include, for example, short-range wireless communication data such as information from nearby wireless LAN APs, base station information, or GPS data.

The servers 401, 403, and 405 of the communication service providers receive the location tracking information collected and transmitted by the emergency position tracking apps on these mobile communication devices. Using positioning means, the servers then identify which mobile communication devices are located at the specified positional coordinates based on their location tracking information.

The positioning means can either be integrated within the servers 401, 403, and 405 of the communication service providers or can be a separate positioning server 900 independent of the servers 401, 403, and 405.

Meanwhile, in this invention, the servers 401, 403, and 405 of the communication service providers should be understood not as a single computer server, but as a collection of server computers that perform various functions. Therefore, it is possible for each function to be performed by separate server computers.

For example, the positioning means may include a database that stores the MAC addresses of wireless LAN APs and their corresponding locations. By analyzing the location tracking information of the mobile communication devices, those with MAC addresses from the wireless LAN AP information that match the location of building 10 can be identified as being present within that building.

In another instance, the positioning means can identify the mobile communication devices, whose GPS locations from the tracking data match the location of building 10, as devices present at that location.

In yet another instance, the positioning means can identify the mobile communication devices present at the site of building 10 by matching their positions, calculated from base station information in the location tracking data, with the location of building 10.

In this manner, the positioning means can identify the mobile communication devices located in building 10 by using the location tracking information of the devices communicating with the base stations nearby the building.

In this embodiment, an independent positioning server 900 is provided. It receives the location tracking information of the mobile communication devices from the communication service provider's servers 401, 403, and 405 and identifies the mobile communication devices present at the specified location.

The positioning server 900 identifies the mobile communication devices present at a specific location, namely in the building 10, and transmits this information to the base station communication and identification device 80. The base station communication and identification device 80 then displays the identified information of the mobile communication devices on its display unit 89.

It should be noted that the information of mobile communication devices identified as being present at the specific location can be displayed on various devices.

For example, the information can be displayed on devices connected to government agency server 310, such as that of the Fire Department or the Police Department.

In displaying the information of the identified mobile communication devices, it is possible to show the number of mobile communication devices present at the specific location and/or the phone numbers of the individual mobile communication devices.

Simply displaying the number of mobile communication devices is also meaningful. For example, in the event of a fire in building 10, the number of mobile communication devices located at the location can be used to estimate the number of people inside the building.

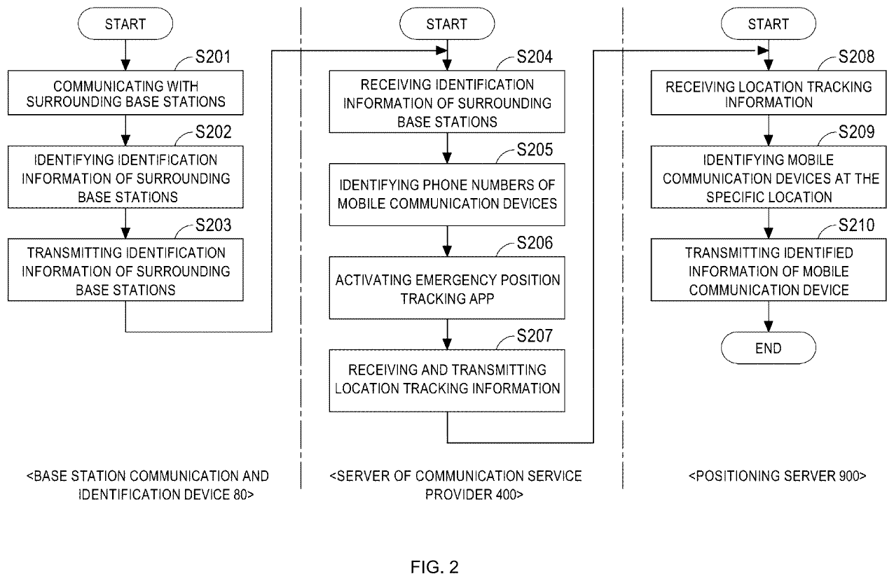

FIG. 2 illustrates the process of identifying the mobile communication devices located at a specific location according to the method of the present invention.

First, the base station communication and identification device 80 communicates with nearby the base stations (Step S201) and identifies the identification information of the surrounding base stations including the identification information of the communicating base station and that of its neighboring base stations (Step S202). This identification information of the surrounding base stations is then transmitted to the communication service provider's server 400 (Step S203). In this case, the information may be relayed through the government agency server 310 and the Korea Telecommunications Operators Association (KTOA) server 350.

The communication service provider's server 400 receives the identification information of the surrounding base stations (Step S204), identifies the phone numbers of the mobile communication devices communicating with the base stations according to the identification information of the surrounding base stations (Step S205), and sends push messages to these mobile communication devices according to their phone numbers to activate the emergency location tracking app 608 (Step S206). The server then receives the location tracking information from these mobile communication devices and transmits this information to the positioning server 900 (Step S207).

The positioning server (900) receives the location tracking information of the mobile communication devices (Step S208) and uses this information to identify the mobile communication devices located at the specific location (Step S209). Subsequently, the information of the mobile communication devices identified as being present at the specific location (e.g., the number and/or phone numbers) is transmitted to the device that displays the information of the identified mobile communication devices, such as the base station communication and identification device (80) (Step S210).

According to the present invention, a mobile short-range wireless communication means 200 can be temporarily provided at the specific location.

In the present invention, the mobile short-range wireless communication means 200 refers to a mobile device that generates short-range wireless communication signals such as Wi-Fi signals or Bluetooth signals.

When the short-range wireless communication means 200 generates short-range wireless communication signals, such as Wi-Fi signals or Bluetooth signals, the emergency location tracking apps on nearby mobile communication devices can scan these signals and recognize them as location tracking information.

The mobile short-range wireless communication means 200, for example, includes a battery, allowing it to be used as a portable device.

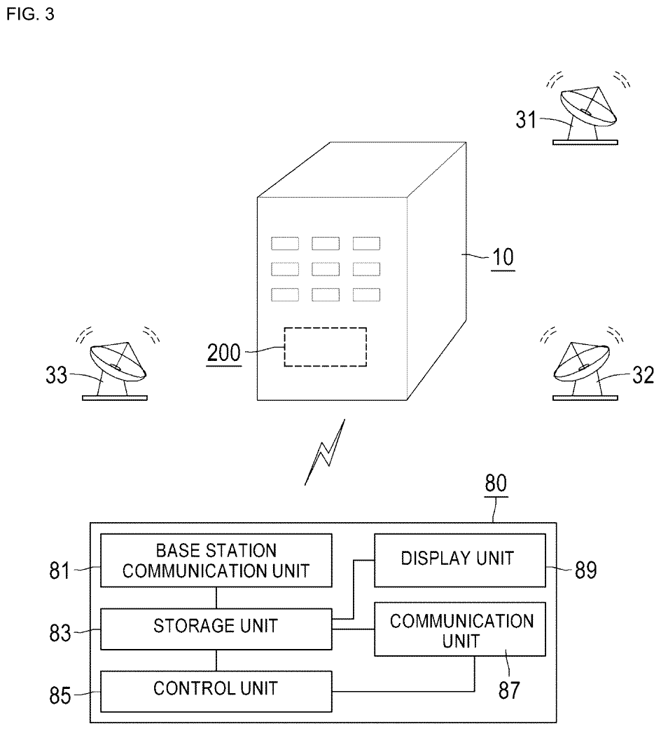

FIG. 3 illustrates this situation.

For example, in the event of a fire in the building 10, the mobile short-range wireless communication means 200 can be thrown into the building.

In such a case, the positioning server 900 can identify that the mobile communication devices, which have the identification information of the temporarily provided mobile short-range wireless communication means 200 from the location tracking information collected and sent by the emergency position tracking apps 608 on the mobile communication devices, are present at the specific location, i.e., the building 10.

For example, if a wireless LAN AP is thrown, the mobile communication devices which have the MAC address of this wireless LAN AP in their location tracking information can be identified as being located at the specific location, i.e., in the building.

According to the present invention, it is preferable that the mobile short-range wireless communication means 200 includes a provision location display means 220 for displaying its location information where it is provided.

Then, the mobile short-range wireless communication means 200 can be provided to the specified location according to the location information displayed by the provision location display means 220.

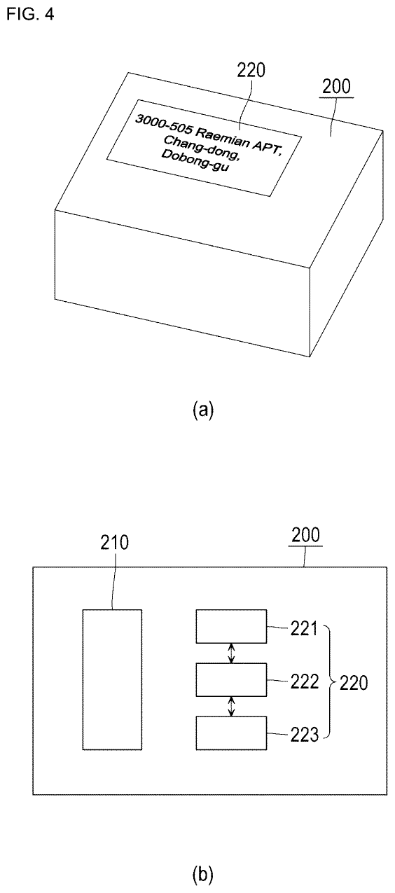

For example, the provision location display means 220 can be attached to the outer surface of the mobile short-range wireless communication means 200 in the form of a label or the like. (FIG. 4(a))

In another instance, the mobile short-range wireless communication means (200) can include a short-range wireless communication signal generation unit (210) that generates the short-range wireless communication signals, and additionally, it can have a provision location display means (220) that includes an input unit (221) for entering location information, a storage unit (222) for storing the inputted location information, and a display unit (223) for displaying the stored location information. (FIG. 4(b))

When the location information where the device is provided is entered through the input unit (221), it is stored in the storage unit (222) and displayed on the display unit (223).

According to the location information displayed by the provision location display means (220), the mobile short-range wireless communication means (200) can be thrown or moved to the specified location (i.e., it can be relocated).

In emergency situations such as fires or terrorist attacks, the device can be thrown to the displayed location to be provided at that desired specific location.

In the case of buildings such as apartments, the interior of subways, or tunnels, the device can be moved and placed at the specified location according to the location information displayed by the provision location display means 220.

The location information displayed by the provision location display means 220 can be presented in various forms, including an address, a map indication with a rough map, or a description of the location to be provided. It is sufficient as long as the person throwing or transporting the mobile short-range wireless communication means 200 can understand it within the context of the situation

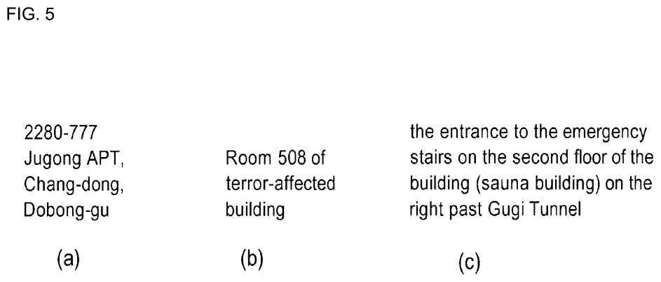

As shown in FIG. 5(a), the address can be displayed, and as shown in FIG. 5(b), if the thrower is positioned directly in front of the building where the terrorist attack is occurring, simply indicating ‘Room 508 of the building’ would suffice.

Additionally, as shown in FIG. 5(c), it is sufficient if the explanation is understandable to the person transporting the mobile short-range wireless communication means 200.

As described, the present invention provides a method for identifying mobile communication devices present at a specific location when that location is given.

1. A method for identifying mobile communication devices located at a specific location, the method comprising:
(a) Surrounding Base Station Identification Step, wherein a base station communication and identification device, which is configured to identify and transmit identification information of surrounding base stations, including that of communicating base station with which it is communicating, by being positioned at or near a specific location, identifies the identification information of the surrounding base stations;
(b) Base Station Identification Information Transmission Step, wherein the identification information of the surrounding base stations identified by the base station communication and identification device is transmitted to servers of communication service providers to which the base station belongs;
(c) Mobile Communication Device Phone Number Identification Step, wherein the servers of the communication service providers identify phone numbers of the mobile communication devices communicating with the base stations according to the identification information of the surrounding base stations;
(d) Emergency Location Tracking App Activation Step, wherein the servers of the communication service providers, having identified the phone numbers of the mobile communication devices, activate emergency position tracking apps installed on the mobile communication devices associated with those phone numbers; wherein the emergency position tracking app is an application that collects and transmits the location tracking information of the mobile communication device on which it is installed,
(e) Specific Location Presence Mobile Communication Device Identification Step, wherein positioning means identify the mobile communication devices located at the specific location based on the location tracking information collected and transmitted by the emergency position tracking apps on the mobile communication devices.

2. The method for identifying mobile communication devices located at a specific location as claimed in claim 1, wherein, in the Surrounding Base Station Identification Step, the identification information of the surrounding base stations includes the identification information of the communicating base station and identification information of neighboring base stations of the communicating base station.

3. (canceled)

4. The method for identifying mobile communication devices located at a specific location as claimed in claim 1, wherein, in the Specific Location Presence Mobile Communication Device Identification Step, the mobile communication devices located at the specific location are identified by using any one or a combination of identification information of short-range wireless communication means, identification information of base stations, or GPS information from the location tracking information.

5. The method for identifying mobile communication devices located at a specific location as claimed in claim 4, wherein information of the mobile communication devices located at the specific location identified by the Specific Location Presence Mobile Communication Device Identification Step includes the number of mobile communication devices located at the specific location and/or the phone numbers of these mobile communication devices.

6. The method for identifying mobile communication devices located at a specific location as claimed in claim 1, wherein:
(a) a mobile short-range wireless communication means, which generates short-range wireless communication signals, is temporarily provided at the specific location, and
(b) in the Specific Location Presence Mobile Communication Device Identification Step, the mobile communication devices that have the identification information of the temporarily provided mobile short-range wireless communication means from the location tracking information collected and transmitted by the emergency position tracking apps of the mobile communication devices are identified as being located at the specific location.

7. A method for identifying mobile communication devices located at a specific location by a communication service provider server, the method comprising:
(a) Mobile Communication Device Phone Number Identification Step, wherein, based on identification information of surrounding base stations identified and transmitted by a base station communication and identification device, which is configured to identify and transmit the identification information of the surrounding base stations, including that of a communicating base station with which it is communicating, by being positioned at or near a specific location, phone numbers of mobile communication devices communicating with the base stations are identified according to the identification information of the surrounding base stations;
(b) Emergency Position Tracking App Activation Step, wherein emergency location tracking apps installed on the mobile communication devices associated with the identified phone numbers are activated; wherein each of the emergency location tracking apps collects and transmits the location tracking information of the mobile communication device on which it is installed;
(c) Specific Location Presence Mobile Communication Device Identification Step, wherein the mobile communication devices located at the specific location are identified based on the location tracking information collected and transmitted by the emergency position tracking apps of the mobile communication devices.

8. The method for identifying mobile communication devices located at a specific location by a communication service provider server as claimed in claim 7, wherein:
(a) a mobile short-range wireless communication means, which generates short-range wireless communication signals, is temporarily provided at the specific location, and
(b) in the Specific Location Presence Mobile Communication Device Identification Step, the mobile communication devices that have the identification information of the temporarily provided mobile short-range wireless communication means from the location tracking information collected and transmitted by the emergency position tracking apps of the mobile communication devices are identified as being located at the specific location.

9. A method for identifying mobile communication devices located at a specific location by a positioning server, the method comprising:
(a) By a communication service provider server,
(a1) based on identification information of surrounding base stations identified and transmitted by a base station communication and identification device, which is configured to identify and transmit the identification information of the surrounding base stations, including that of a communicating base station with which it is communicating, by being positioned at or near a specific location, identifying phone numbers of mobile communication devices communicating with base stations according to the identification information of surrounding base stations; and
(a2) activating emergency position tracking apps installed on the mobile communication devices associated with the identified phone numbers and receiving location tracking information collected and transmitted by the emergency position tracking apps, wherein each of the emergency position tracking apps collects and transmits the location tracking information of the mobile communication device on which it is installed; and
(b) Specific Location Presence Mobile Communication Device Identification Step, wherein the positioning server receives the location tracking information collected and transmitted by the emergency position tracking apps from the communication service provider server and identifies the mobile communication devices located at the specific location.

10. The method for identifying mobile communication devices located at a specific location by a positioning server as claimed in claim 9, wherein
(a) a mobile short-range wireless communication means, which generates short-range wireless communication signals, is temporarily provided at the specific location, and
(b) in the Specific Location Presence Mobile Communication Device Identification Step, the mobile communication devices that have the identification information of the temporarily provided mobile short-range wireless communication means from the location tracking information collected and transmitted by the emergency position tracking apps of the mobile communication devices are identified as being located at the specific location.

11. A method for identifying mobile communication devices located at a specific location by a communication service provider server, the method comprising:
(a) based on identification information of surrounding base stations identified and transmitted by a base station communication and identification device, which is configured to identify and transmit the identification information of the surrounding base stations, including that of a communicating base station with which it is communicating, by being positioned at or near a specific location, identifying phone numbers of mobile communication devices communicating with the base stations according to the identification information of the surrounding base stations,
(b) activating emergency position tracking apps installed on the mobile communication devices associated with the identified phone numbers and receiving location tracking information collected and transmitted by the emergency position tracking apps, wherein the emergency position tracking app is an application that collects and transmits the location tracking information of the mobile communication device on which it is installed, and
(c) transmitting the location tracking information collected and transmitted by the emergency position tracking apps to a positioning server,
(d) wherein the positioning server identifies the mobile communication devices located at the specific location according to the location tracking information collected and transmitted by the emergency position tracking apps of the mobile communication devices.

12. The method for identifying mobile communication devices located at a specific location by a communication service provider server as claimed in claim 11, wherein
(a) a mobile short-range wireless communication means, which generates short-range wireless communication signals, is temporarily provided at the specific location, and
(b) the positioning server identifies that the mobile communication devices, which have the identification information of the temporarily provided mobile short-range wireless communication means from the location tracking information collected and transmitted by the emergency position tracking apps on the mobile communication devices are located at the specific location.

13. (canceled)

14. (canceled)

15. A method for identifying mobile communication devices located at a specific location, the method comprising:
(a) Temporary Provision of a Mobile Short-range Wireless Communication Means Step, wherein a mobile short-range wireless communication means, which is mobile, generates short-range wireless communication signals, and has a provision location display means that displays location information where it is provided, is temporarily provided at a specific location according to the location information;
(b) Surrounding Base Station Identification Step, wherein a base station communication and identification device, which is configured to identify and transmit identification information of surrounding base stations, including that of a communicating base station with which it is communicating, by being positioned at or near a specific location, identifies the identification information of the surrounding base stations;
(c) Base Station Identification Information Transmission Step, wherein the identification information of the surrounding base stations identified by the base station communication and identification device is transmitted to servers of communication service providers to which the base station belongs;
(d) Mobile Communication Device Phone Number Identification Step, wherein the servers of the communication service providers identify phone numbers of mobile communication devices communicating with the base stations according to the identification information of the surrounding base stations;
(e) Emergency Location Tracking App Activation Step, wherein the servers of the communication service providers, having identified the phone numbers of the mobile communication devices, activate emergency position tracking apps installed on the mobile communication devices associated with those phone numbers, wherein the emergency position tracking app is an application that collects and transmits the location tracking information of the mobile communication device on which it is installed, and
(f) Specific Location Presence Mobile Communication Device Identification Step, wherein positioning means identify that the mobile communication devices, which have identification information of the temporarily provided mobile short-range wireless communication means from the location tracking information collected and transmitted by the emergency position tracking apps on the mobile communication devices, are located at the specific location.

16. The method for identifying mobile communication devices located at a specific location as claimed in claim 15, wherein the location information at a specific location includes an address, a map indication with a rough map, or a description of the location to be provided.

17. The method for identifying mobile communication devices located at a specific location as claimed in claim 16, wherein the temporary provision step of a mobile short-range wireless communication means includes throwing the mobile short-range wireless communication means to the specific location or moving and placing it at the specific location according to the location information.

18. The method for identifying mobile communication devices located at a specific location as claimed in claim 17, wherein in the surrounding base station identification step, the identification information of the surrounding base stations includes the identification information of the communicating base station and the identification information of the neighboring base stations of the communicating base station.

19. (canceled)

20. The method for identifying mobile communication devices located at a specific location as claimed in claim 15, wherein information of the mobile communication devices located at the specific location identified by the Specific Location Presence Mobile Communication Device Identification Step includes the number of mobile communication devices located at the specific location and/or the phone numbers of these mobile communication devices.

21. A method for identifying mobile communication devices located at a specific location by a communication service provider server, the method comprising:
(a) Mobile Communication Device Phone Number Identification Step, wherein, with respect to a specific location where a mobile short-range wireless communication means, which is mobile, generates short-range wireless communication signals, and has a provision location display means that displays location information where it is provided, is temporarily provided, based on identification information of surrounding base stations identified and transmitted by a base station communication and identification device, which is configured to identify and transmit the identification information of the surrounding base stations, including that of a communicating base station with which it is communicating, by being positioned at or near the specific location, phone numbers of mobile communication devices communicating with the base stations are identified according to the identification information of the surrounding base stations;
(b) Emergency Position Tracking App Activation Step, wherein emergency position tracking apps installed on the mobile communication devices associated with the identified phone numbers are activated, wherein each of the emergency position tracking apps collects and transmits location tracking information of the mobile communication device on which it is installed; and
(c) Specific Location Presence Mobile Communication Device Identification Step, wherein the mobile communication devices, which have identification information of the temporarily provided mobile short-range wireless communication means from the location tracking information collected and transmitted by the emergency position tracking apps on the mobile communication devices, are identified as being present at the specific location.

22. A method for identifying mobile communication devices located at a specific location by a positioning server, the method comprising:
(a) by a communication service provider server,
(a1) with respect to a specific location where a mobile short-range wireless communication means, which is mobile, generates short-range wireless communication signals, and has a provision location display means that displays location information where it is provided, is temporarily provided, based on identification information of surrounding base stations identified and transmitted by a base station communication and identification device, which is configured to identify and transmit the identification information of the surrounding base stations, including that of a communicating base station with which it is communicating, by being positioned at or near the specific location, identifying phone numbers of mobile communication devices communicating with the base stations according to the identification information of the surrounding base stations;
(a2) activating emergency position tracking apps installed on the mobile communication devices associated with the identified phone numbers and receiving location tracking information collected and transmitted by the emergency position tracking apps, wherein each of the emergency position tracking apps collects and transmits location tracking information of the mobile communication device on which it is installed, and
(b) Specific Location Presence Mobile Communication Device Identification Step wherein the position server receives the location tracking information collected and transmitted by the emergency position tracking apps transmitted from the communication service provider server and identifies that the mobile communication devices, which have identification information of the temporarily provided mobile short-range wireless communication means from the location tracking information are present at the specific location.

23. A method for identifying mobile communication devices located at a specific location by a communication service provider server, the method comprising:
(a) with respect to a specific location where a mobile short-range wireless communication means, which is mobile, generates short-range wireless communication signals, and has a provision location display means that displays location information where it is provided, is temporarily provided, based on identification information of surrounding base stations identified and transmitted by a base station communication and identification device, which is configured to identify and transmit the identification information of the surrounding base stations, including that of a communicating base station with which it is communicating, by being positioned at or near the specific location, identifying phone numbers of mobile communication devices communicating with the base stations according to the identification information of the surrounding base stations;
(b) activating emergency position tracking apps installed on the mobile communication devices associated with the identified phone numbers and receiving location tracking information collected and transmitted by the emergency position tracking apps, wherein each of the emergency position tracking apps collects and transmits the location tracking information of the mobile communication device on which it is installed, and
(c) transmitting the location tracking information collected and transmitted by the emergency position tracking apps to a positioning server,
(d) wherein the position server identifies that the mobile communication devices, which have identification information of the temporarily provided mobile short-range wireless communication means from the location tracking information are present at the specific location.

24. With respect to a method for identifying mobile communication devices located at a specific location comprising:
(a1) Temporary Provision of a Mobile Short-range Wireless Communication Means Step, wherein a mobile short-range wireless communication means, which is mobile, generates short-range wireless communication signals, and has a provision location display means that displays location information where it is provided, is temporarily provided at a specific location according to the location information;
(a2) Surrounding Base Station Identification Step, wherein a base station communication and identification device, which is configured to identify and transmit identification information of surrounding base stations, including that of a communicating base station with which it is communicating, by being positioned at or near a specific location, identifies the identification information of the surrounding base stations;
(a3) Base Station Identification Information Transmission Step, wherein the identification information of the surrounding base stations identified by the base station communication and identification device is transmitted to servers of communication service providers to which the base station belongs;
(a4) Mobile Communication Device Phone Number Identification Step, wherein the servers of the communication service providers identify phone numbers of the mobile communication devices communicating with the base stations according to the identification information of the surrounding base stations;
(a5) Emergency Location Tracking App Activation Step, wherein the servers of the communication service providers, having identified the phone numbers of the mobile communication devices, activate emergency position tracking apps installed on the mobile communication devices associated with those phone numbers, wherein the emergency position tracking app is an application that collects and transmits the location tracking information of the mobile communication device on which it is installed, and
(a6) Specific Location Presence Mobile Communication Device Identification Step, wherein positioning means identify that the mobile communication devices, which have identification information of the temporarily provided mobile short-range wireless communication means from the location tracking information collected and transmitted by the emergency position tracking apps on the mobile communication devices, are present at the specific location,
(b) the mobile short-range wireless communication means used for the method for identifying mobile communication devices located at a specific location.

25. With respect to a method for identifying mobile communication devices located at a specific location comprising:
(a1) Temporary Provision of a Mobile Short-range Wireless Communication Means Step, wherein a mobile short-range wireless communication means, which is mobile, generates short-range wireless communication signals, and has a provision location display means that displays location information where it is provided, is temporarily provided at a specific location according to the location information;
(a2) Surrounding Base Station Identification Step, wherein a base station communication and identification device, which is configured to identify and transmit identification information of surrounding base stations, including that of a communicating base station with which it is communicating, by being positioned at or near a specific location, identifies the identification information of the surrounding base stations;
(a3) Base Station Identification Information Transmission Step, wherein the identification information of the surrounding base stations identified by the base station communication and identification device is transmitted to servers of communication service providers to which the base station belongs;
(a4) Mobile Communication Device Phone Number Identification Step, wherein the servers of the communication service providers identify phone numbers of the mobile communication devices communicating with the base stations according to the identification information of the surrounding base stations;
(a5) Emergency Location Tracking App Activation Step, wherein the servers of the communication service providers, having identified the phone numbers of the mobile communication devices, activate emergency position tracking apps installed on the mobile communication devices associated with those phone numbers, wherein the emergency position tracking app is an application that collects and transmits the location tracking information of the mobile communication device on which it is installed, and
(a6) Specific Location Presence Mobile Communication Device Identification Step, wherein positioning means identify that the mobile communication devices, which have identification information of the temporarily provided mobile short-range wireless communication means from the location tracking information collected and transmitted by the emergency position tracking apps on the mobile communication devices, are present at the specific location,
(b) the base station communication and identification device used for the method for identifying mobile communication devices located at a specific location.
